(19) United States
(12) Patent Application Publication
(10) Pub. No.: US 2012/0329410 A1
(43) Pub. Date: Dec. 27, 2012

(54) Thermal-based flow control

(75) Inventors: Swaminathan Balakrishnan, Sunnyvale, CA (US); Reza Shahidi, San Diego, CA (US); Ammar T. Kitabi, San Diego, CA (US); Chintan S. Shah, San Diego, CA (US); Louis A. Benavidez, San Diego, CA (US)

(73) Assignee: QUALCOMM Incorporated, San Diego, CA (US)

(21) Appl. No.: 13/314,019

(22) Filed: Dec. 7, 2011

Related U.S. Application Data
(60) Provisional application No. 61/501,068, filed on Jun. 24, 2011.

(51) Int. Cl. H04B 1/04

(52) U.S. Cl. 455/127.1

(57) ABSTRACT

Methods, devices, and apparatuses are provided for detecting that a temperature of at least a portion of a mobile device is above a mitigation threshold, adjusting transmit power, used on a first channel by said mobile device, by a first backoff amount during a first backoff interval, based, at least in part, on said detected temperature. Further included is suppressing a transmission during a response interval used on a second channel by said mobile device.

### CROSS-REFERENCE TO RELATED APPLICATION

This application claims the benefit of priority to U.S. Provisional Application Ser. No. 61/501,068 filed on Jun. 24, 2011, whish is expressly herein incorporated by reference

### BACKGROUND

1. Field

The subject matter disclosed herein relates to temperature mitigation in a mobile device.

2. Information

As mobile devices begin to rely increasingly on data-intensive applications, operation of many mobile devices may depend on an ability to transmit through and receive data from communications networks at high data rates. For transmitting on an output channel at a high data rate, such as while uploading streaming content, for example, power supplied by a transmit power amplifier may be maintained at a relatively high level so that a signal having a sufficiently high carrier-to-noise ratio may be received from the mobile device at a cellular base station.

Unfortunately, as mobile devices include circuits, components, and subsystems packed into smaller and smaller form factors, transmission of high-power signals over an extended period may result in the mobile device attaining a temperature that may be uncomfortable for a user to hold and/or may lead to malfunctioning of the device. Previous solutions to these difficulties have focused only on decreasing a transmit power by a fixed amount. However, merely reducing output power by a fixed amount may be insufficient to adequately reduce the operating temperature of a mobile device.

Further, merely reducing output power of a mobile device may result in degradation of the carrier-to-noise ratio of a signal received from the mobile device by a cellular base station. In many instances, a reduction of a transmit signal level of a mobile device may result in the cellular base station determining that the device has gone off-line, which may result in termination of the call by the cellular communications system.

### SUMMARY

In a particular implementation, a method comprises detecting that a temperature of at least a portion of a mobile device is above a mitigation threshold. The method additionally comprises adjusting transmit power, used on a first channel by the mobile device, by a first backoff amount during a first backoff interval, based, at least in part, on the detected temperature. The method further comprises suppressing a transmission during a response interval used on a second channel by the mobile device.

In another implementation, an apparatus comprises means for detecting that a temperature of at least a portion of a mobile device is above a mitigation threshold. The method also comprises means for adjusting transmit power used by the mobile device by a first backoff amount during a first backoff interval and for suppressing transmissions during a response interval, based, at least in part, on the detected temperature.

In another implementation, an article comprises a non-transitory storage medium comprising machine-readable instructions stored thereon which are executable by a processor of a mobile device to detect that a temperature of at least a portion of a mobile device is above a mitigation threshold, to adjust transmit power of the mobile device by a first backoff amount during a first backoff interval based, at least in part, on the detected temperature, and to suppress a transmission during a response interval used on a second channel by the mobile device, and to suppress a transmission during a response interval used on a second channel by the mobile device.

In another implementation, a mobile device comprises one or more temperature sensors and one or more processors to determine whether a signal from the one or more temperature sensors indicates that a portion of the mobile device has reached a temperature greater than a mitigation threshold and to adjust transmit power of the mobile device by a first backoff amount during a first backoff interval, based, at least in part, on an output signal of the one or more temperature sensors and to suppress a transmission during a response interval used on a second channel by the mobile device

### BRIEF DESCRIPTION OF DRAWINGS

Non-limiting and non-exhaustive aspects are described with reference to the following figures, wherein like reference numerals refer to like parts throughout the various figures.

FIG. 1 shows a plot of transmit power versus time of a signal transmitted by a mobile device on a first channel according to an implementation.

FIG. 2 shows a plot of transmit power versus time of a signal transmitted by a mobile device on a second channel according to implementation.

FIG. 3 is a diagram showing power of first and second signals transmitted during step timer periods from a power amplifier of a mobile device according to an implementation.

FIG. 4 is a diagram showing transmitted power of first and second signals transmitted from a power amplifier of a mobile device according to an implementation.

FIG. 5 is a schematic diagram illustrating an example computing environment associated with a mobile device according to an implementation.

FIG. 6 is a flowchart illustrating a process of temperature mitigation in a mobile device according to an implementation.

### DETAILED DESCRIPTION

Devices, methods, and apparatuses are provided that may be implemented for temperature mitigation in a mobile device. In implementations, in response to a temperature of at least a portion of a mobile device exceeding a mitigation threshold, an output power transmit level may be adjusted downward by a first “backoff” amount during a first backoff interval. In response to a first backoff interval expiring, the transmit power may be adjusted upward by the first backoff amount, and the temperature of the portion of the mobile device may be measured a second time. In an implementation, in response to the portion of the mobile device remaining above the mitigation threshold, a transmit power level may again be adjusted, during a second backoff interval, by the first backoff amount.

In a particular implementation, in response to the temperature of at least a portion of the mobile device exceeding a mitigation threshold after adjusting transmit power by a first backoff amount over at least two backoff intervals, transmit power may be adjusted by a second backoff amount over at least two additional backoff intervals. In an implementation, the second backoff amount may be an integer multiple of the amount of the first backoff amount. In an implementation, one or more of first and second backoff amounts may be determined based, at least in part, on information states stored in a lookup table or in response to a temperature-sensing control system. In an implementation, transmit power may not be allowed to fall below a lower transmit power level.

In another implementation, a mobile device may transmit using first and second channels and may employ different temperature mitigation techniques for the first and second channels. In an example, for a first channel, a mobile device may adjust transmit power by a first backoff amount during a first backoff interval, and may adjust transmit power by a second backoff amount during a second backoff interval. For a second channel, a mobile device may suppress transmissions during one or more response intervals.

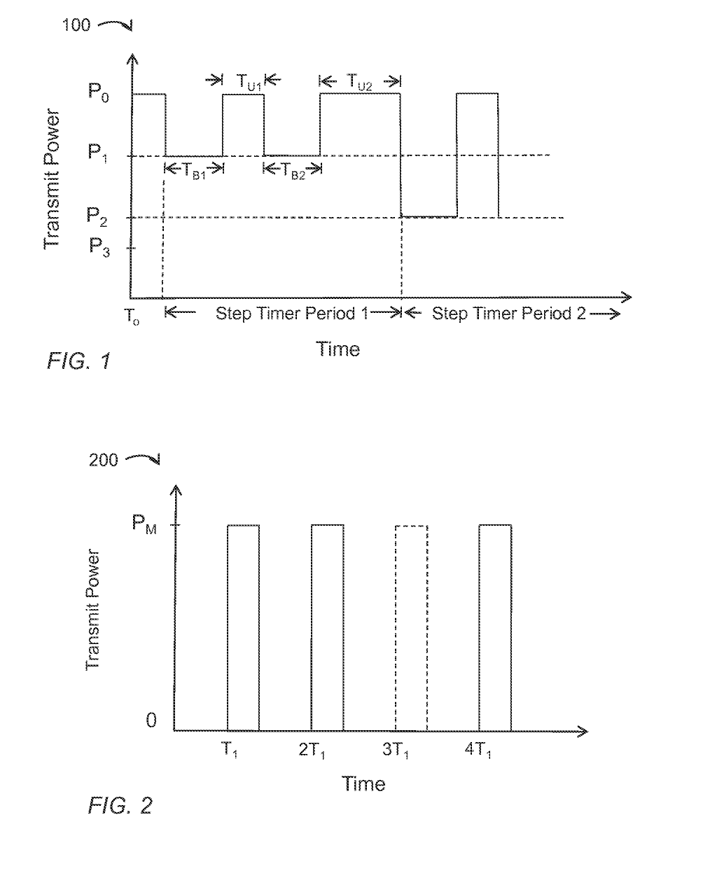

FIG. 1 shows a plot (100) of transmit power versus time of a signal transmitted by a mobile device on a first channel according to an implementation. At a time T₀, a mobile device may transmit at a power level of approximately P₀. In an embodiment, P₀ may represent a reverse link transmit power selected by one or more processing units of the mobile device or may represent a transmit power selected by a cellular base station as part of a typical call setup process. In an example, plot 100 may represent transmit power as a function of time used on a “traffic” channel that may carry signals expressing states corresponding to voice and/or data transmitted from a mobile device to a cellular base station. However it should be understood that claimed subject matter is not limited in this respect.

In an implementation, a temperature of a portion of a mobile device may be measured at approximately T₀. In response to detecting that a portion of the mobile device may be above a mitigation threshold, the mobile device may adjust transmit power by a first backoff amount from a value of P₀ to P₁. In an implementation, transmit power may be adjusted during a first backoff interval which may be identified as T_{B1} in FIG. 1. After T_{B1} has expired, transmit power may be adjusted upward by the first backoff amount to a previous value, which may be identified as P₀.

In implementations, transmit power may be returned to level P₀ and temperature of a portion of the mobile device may again be measured. In response to the measured temperature remaining above the mitigation threshold, transmit power may be reduced a second time by the first backoff amount after the expiration of a period approximately equal to T_{U1}. Transmit power may again be maintained at a level approximately equal to P₁ for a second backoff interval, which in this case may be approximated by T_{B2}.

In an implementation, transmit power of the mobile device may again be increased to P₀, and temperature of a portion of the mobile device may again be measured. In response to the temperature of a portion of the mobile device remaining above a mitigation threshold, output power of the mobile device may be adjusted by a second backoff amount, to P₂, as shown in FIG. 1, after the expiration of a period approximately equal to T_{U2}. In an implementation, adjusting power from P₀ to P₂ may represent approximately two times the backoff amount represented by adjusting power from P₀ to P₁, although claimed subject matter is not limited in this respect.

In the implementation of FIG. 1, a step timer period may be used to distinguish a first power backoff adjustment period from a second power backoff adjustment period. For example, step timer period 1 may identify a time period during which power may be adjusted by a first backoff amount, such as from P₀ to P₁. During step timer period 2, for example, transmit power may be adjusted by a second backoff amount, such as from P₀ to P₂, for one or more backoff intervals. Between backoff intervals, a temperature of a portion of the mobile device may be measured to determine whether the portion of the mobile device remains above a mitigation threshold.

In particular implementations, step timer periods in addition to step timer periods 1 and 2 may be employed. During additional step timer periods, transmit power may be reduced by additional amounts, and claimed subject matter is not limited in this respect. Additionally, although the implementation of FIG. 1 identifies adjustment of transmit power by a second backoff amount, which may be approximately as two-times a first backoff amount, claimed subject matter is not limited in this respect. In other implementations, backoff amounts may be related to each other by integer multiples, such as three, four, five, and so forth, or may be related by non-integer multiples.

In one possible implementation, transmit power may be adjusted in an incremental manner over a number of timer period. For example, for a transmit power of 630.0 milliwatts (mW), which is approximately 28.0 decibels (dB) above 1.0 mW, or 28.0 dBm, a first backoff amount may correspond to 1.0 dBm, or approximately 130.0 mW. Accordingly, during a first step timer period, output power may be adjusted from approximately 630.0 mW to approximately 500.0 mW. In the event that a temperature of a portion of the mobile device remains above a mitigation threshold, transmit power may be adjusted by 2.0 dBm, or from approximately 500.0 mW to approximately 399.0 mW. Additional incremental adjustments in output power may continue so long as at least a portion of the mobile device remains at a temperature that may be above a mitigation threshold. The values and quantities in the particular example above are merely example values and qualities introduced for illustration, and claimed subject matter is not limited in this respect

In FIG. 1, a minimum transmit power level may be represented by P₃. In an implementation, a power backoff amount may not be allowed to reduce transmit power to a level less than P₃. In an example, P3 may be determined according to an estimated link margin between the mobile device and a cellular base station. However, this is merely an example, and claimed subject matter is not limited in this respect.

FIG. 2 shows a plot (200) of transmit power versus time of a signal transmitted by a mobile device on a second channel according to an implementation. In one implementation, plot 200 may represent transmit power as a function of time for a control channel used by a cellular communications system to convey information states comprising acknowledgment that a previously transmitted signal has been received.

In an implementation, plot 100 of FIG. 1, and plot 200 of FIG. 2 may represent transmit power levels, as functions of time, used by a mobile device to convey signals representing traffic and control information states, respectively, using separate communications channels and separate time scales. For example, a traffic channel may be used by a mobile device to convey information signals representing voice and/or data states, while a control channel may be used to convey signals representing control information for a traffic channel.

In an implementation, a control channel may transmit control information states during periodic response intervals at integer multiples of time T₁ (e.g. T₁, 2T₁, 3T₁, and so on) as shown in FIG. 2. For example, in FIG. 2, an acknowledge (ACK) signal may be periodically transmitted by a mobile device in response to successful reception of at least a portion of a message transmitted to the mobile device from a cellular base station. As each portion is successfully received and successfully decoded by the mobile device, an acknowledgment (ACK) may be transmitted by the mobile device.

In an implementation, a method for temperature mitigation in a mobile device may comprise suppressing one or more ACK signals from the mobile device during a periodic response interval. In FIG. 2, for example, after transmitting ACK signals at times T₁ and 2T₁, a periodic ACK scheduled for transmission at 3T₁ may be suppressed. At time 4T₁, a mobile device may resume transmitting an ACK signal at approximately regular (e.g. periodic) intervals. In an implementation, by occasionally suppressing transmissions from a second channel, such as a traffic channel, a mobile device may perform temperature mitigation.

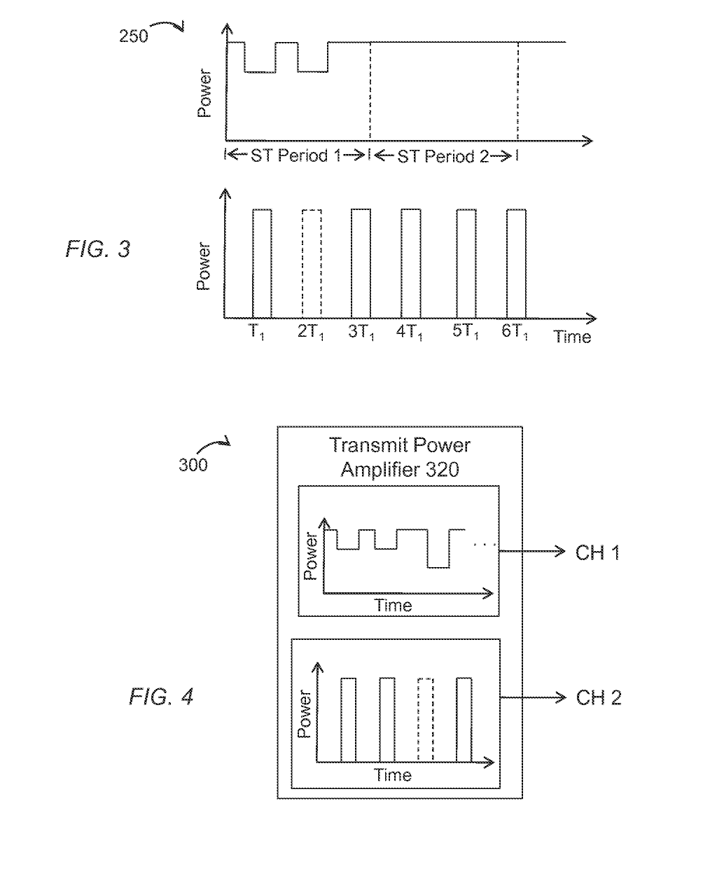

Although FIG. 2 shows only a single suppression of transmission scheduled for a response interval, other implementations may suppress a higher number of transmissions scheduled for response intervals. For example, FIG. 3 shows a plot (250) of transmit power vs. time of a signal transmitted by mobile device on a second channel according to an implementation. In FIG. 3, an ACK signal scheduled for transmission at 2T₁ is suppressed during a first step timer period (ST Period 1). During a second step timer period (ST Period 2) an implementation, no ACK signals are suppressed.

Although FIG. 3 illustrates the suppression of only a single ACK signal during a backoff interval, in other implementations two out of four or perhaps three out of four transmissions scheduled for response intervals (i.e. T₁, 2T₁, 3T₁, and so forth) may be suppressed. In other implementations, a lesser number of transmissions scheduled for response intervals may be suppressed, such as one out of every eight (12.5%), one out of every ten (10%), and so on, and claimed subject matter is not limited in this respect. Further, nothing prevents the use of additional transmit channels that may be employed by a mobile device in association with other mobile communications protocols. Further, it should be noted that claimed subject matter is not limited to any particular mobile communications standard or protocol.

FIG. 4 is a diagram (300) showing transmitted power versus time of first and second signals transmitted from a power amplifier of a mobile device according to an implementation. In FIG. 4, for example, transmit power amplifier 320 may differentiate between a first channel (CH 1) and a second channel (CH2). In an implementation, power transmitted on a first channel may be adjusted by a first backoff amount during at least two backoff intervals over a first step timer period. Prior to adjusting output power, a temperature of at least a portion of a mobile device may be measured to determine whether the portion of the mobile device maintains a temperature beyond a mitigation threshold. In response to the expiration of a first step timer period, temperature of a portion of the mobile device remains above a mitigation threshold, power may be adjusted by a second backoff amount for one or more backoff intervals over a second step timer period. In an implementation, a second backoff amount may be an integer multiple of a first backoff amount. In at least one implementation, power transmitted on a first channel may be adjusted by a first backoff amount while, simultaneously, suppressing ACK signals present on a second channel.

FIG. 4 shows occasional suppression of transmissions on a second channel (CH2) as a result of a measured temperature being above a mitigation threshold. In various implementations, signals transmitted by way of the second channel may be inhibited to reduce temperature of at least a portion of a mobile device. In an implementation, one out of four (25%) transmitted signals may be suppressed, while in other implementations, a higher or lower percentage of transmissions may be suppressed.

FIG. 5 is a schematic diagram illustrating an implementation of an example computing environment 400 that may include one or more networks or devices capable of partially or substantially implementing or supporting one or more processes for temperature mitigation in a mobile device. It should be appreciated that all or part of various devices or networks shown in computing environment 400, processes, or methods, as described herein, may be implemented using various hardware, firmware, or any combination thereof along with software.

Computing environment 400 may include, for example, a mobile device 402, which may be communicatively coupled to any number of other devices, mobile or otherwise, via a suitable communications network, such as a cellular telephone network, the Internet, mobile ad-hoc network, wireless sensor network, or the like. In an implementation, mobile device 402 may be representative of any electronic device, appliance, or machine that may be capable of exchanging information over any suitable communications network. For example, mobile device 402 may include one or more computing devices or platforms associated with, for example, cellular telephones, satellite telephones, smart telephones, personal digital assistants (PDAs), laptop computers, personal entertainment systems, e-book readers, tablet personal computers (PC), personal audio or video devices, personal navigation devices, or the like. In certain example implementations, mobile device 402 may take the form of one or more integrated circuits, circuit boards, or the like that may be operatively enabled for use in another device. Although not shown, optionally or alternatively, there may be additional devices, mobile or otherwise, communicatively coupled to mobile device 402 to facilitate or otherwise support one or more processes associated with computing environment 400. Thus, unless stated otherwise, to simplify discussion, various functionalities, elements, components, etc. are described below with reference to mobile device 402 may also be applicable to other devices not shown so as to support one or more processes associated with example computing environment 400.

Memory 404 may represent any suitable or desired information storage medium. For example, memory 404 may include a primary memory 406 and a secondary memory 408. Primary memory 406 may include, for example, a random access memory, read only memory, etc. While illustrated in this example as being separate from a processing unit 410, it should be appreciated that all or part of primary memory 406 may be provided within or otherwise co-located/coupled with processing unit 410. Secondary memory 408 may include, for example, the same or similar type of memory as primary memory or one or more information storage devices or systems, such as, for example, a disk drive, an optical disc drive, a tape drive, a solid state memory drive, etc. In certain implementations, secondary memory 408 may be operatively receptive of, or otherwise enabled to be coupled to, a non-transitory computer-readable medium 412.

Computer-readable medium 412 may include, for example, any medium that can store or provide access to information, code or instructions (e.g., an article of manufacture, etc.) for one or more devices associated with computing environment 400. For example, computer-readable medium 412 may be provided or accessed by processing unit 410. As such, in certain example implementations, the methods or apparatuses may take the form, in whole or part, of a computer-readable medium that may include computer-implementable instructions stored thereon, which, in response to being executed by at least one processing unit or other like circuitry, may enable processing unit 410 or the other like circuitry to perform all or portions of a location determination processes, sensor-based or sensor-supported measurements (e.g., acceleration, deceleration, orientation, tilt, rotation, etc.), extraction/computation of features from inertial sensor signals, classifying an activity co-located with a user of mobile device, or any like processes to facilitate or otherwise support rest detection of mobile device 402. In certain example implementations, processing unit 410 may be capable of performing or supporting other functions, such as communications, gaming, or the like.

Processing unit 410 may be implemented in hardware or a combination of hardware and software. Processing unit 410 may be representative of one or more circuits capable of performing at least a portion of information computing technique or process. By way of example but not limitation, processing unit 410 may include one or more processors, controllers, microprocessors microcontrollers, application specific integrated circuits, digital signal processors, programmable logic devices, field programmable gate arrays, or the like, or any combination thereof.

Mobile device 402 may include various components or circuitry, such as, for example, one or more temperature sensors 413, or various other sensor(s) 414, such as a magnetic compass, a gyroscope, a video sensor, a gravitometer, etc. to facilitate or otherwise support one or more processes associated with computing environment 400. For example, such sensors may provide analog or digital signals to processing unit 410. Although not shown, it should be noted that mobile device 402 may include an analog-to-digital converter (ADC) for digitizing analog signals from one or more sensors. Optionally or alternatively, such sensors may include a designated (e.g., an internal, etc.) ADC(s) to digitize respective output signals, although claimed subject matter is not so limited.

In an implementation, processing unit 410, as a result of output signals from temperature sensor 413, may employ a temperature-sensing control system which instructs transmit power amplifier 420 to adjust transmit power amounts of transmit power amplifier 420 to desired backoff amount. In one implementation, processing unit 410 adjusts transmit power output levels in decibel (dB) increments, such as 1.0 dB, 2.0 dB, 3.0 dB, and so on. Adjustments may be based, at least in part, on a difference between a measured temperature and a mitigation threshold temperature. In one particular implementation, a temperature measured as being a relatively small amount, such as 1.0° C. to 3.0° C., above a temperature mitigation threshold may initiate the adjustment of output power by a relatively small backoff amount of, for example, 0.5 dB, 1.0 dB, and so on. In the event that a second temperature measurement indicates that a portion of a mobile device remains above a temperature mitigation threshold, output power may be adjusted by an integer multiple of a first backoff amount, such as, for example, 1.0 dB, 2.0 dB, and so on.

In another implementation, a temperature measured as being a relatively large amount, such as 5.0° C., to 10.0° C., above a temperature mitigation threshold may initiate adjusting output power by a relatively larger backoff amount of, for example, 3.0 dB, 4.0 dB, and so on. In the event that a second temperature measurement indicates that a portion of a mobile device remains above the temperature mitigation threshold, output power may be adjusted by an integer multiple of a first backoff amount, such as, for example, 6.0 dB, 8.0 dB, and so on.

In another implementation, a temperature measured as being a small amount above a temperature mitigation threshold may initiate adjustments of, for example, of specific increments in milliwatts, such as 25.0 mW, 50.0 mW, and so on. In the event that a second temperature measurement indicates that a portion of a mobile device remains above a temperature mitigation threshold, transmit power may be adjusted by an integer multiple of a previous backoff amount, such as 1.0 mW, 1.5 mW, and so on.

In another implementation, a temperature measured as being a large amount above a temperature mitigation threshold may result in adjusting output power by a larger amount, such as 100.0 mW, 150.0 mW, and so on. In the event that a second temperature measurement indicates that a portion of a mobile device remains above the mitigation threshold, transmit power may be adjusted by an integer multiple of the previous backoff amount, such as 200.0 mW, 300.0 mW, and so on.

In an implementation, transmit power amplifier 420 may differentiate between first and second transmit channels. For example, power amplifier 420 may adjust an transmit power level used by a first channel over a step timer period while suppressing scheduled transmissions at one or more response intervals used by a second channel.

In an implementation, primary memory 406 and/or secondary memory 408 may comprise a lookup table, accessed by processing unit 410, for associating a measured temperature with a backoff amount. In one example, in response to a measured temperature exceeding a temperature mitigation threshold by a relatively small amount, entries in a lookup table may indicate to processing unit 410 an adjustment in transmit power by a small amount. In another example, in response to a measured temperature exceeding the temperature mitigation threshold by a larger amount, information states stored in a lookup table may indicate a larger adjustment in output power.

In an implementation, memory 404, operating conjunction with temperature sensor 413 and transmit power amplifier 420 may also cooperate in suppressing transmissions during a response interval of, for example, a control channel used by a mobile device. In an example, in the event that temperature sensor 413 detects a temperature of a portion of a mobile device that exceeds a temperature mitigation threshold by a small amount, such as 1.0° C. or 2.0° C., a lower percentage (e.g. 5%, 10%, and so on) of transmissions scheduled for particular response intervals may be suppressed. In another example, in the event that a larger difference between a measured temperature and a temperature mitigation threshold may be detected, a higher percentage (e.g. 25%, 50%, and so on) of transmissions scheduled for particular response intervals may be suppressed. A lookup table may store states that associate a difference between a measured temperature and a temperature mitigation threshold with percentage of transmissions that may be suppressed.

Although not shown, mobile device 402 may also include a memory or information buffer to collect suitable or desired parameters, such as, for example, temperature measurement values, as previously mentioned. Mobile device may also include a power source, for example, to provide power to some or all of the components or circuitry of mobile device 402. A power source may be a portable power source, such as a battery, for example, or may comprise a fixed power source, such as an outlet (e.g. in a house, electric charging station, car, etc.). It should be appreciated that a power source may be integrated into (e.g., built-in, etc.) or otherwise supported by (e.g., stand-alone, etc.) mobile device 402.

Mobile device 402 may include one or more connection bus 416 (e.g., buses, lines, conductors, optic fibers, etc.) to operatively couple various circuits together, and a user interface 418 (e.g., display, touch screen, keypad, buttons, knobs, microphone, speaker, trackball, data port, etc.) to receive user input, facilitate or support sensor-related signal measurements, or provide information to a user. Mobile device 402 may further include a power amplifier 420 that may interface with a modulator, antenna, and so forth, to allow for communication with one or more other devices or systems over one or more suitable communications channels used by one or more communications networks, as indicated

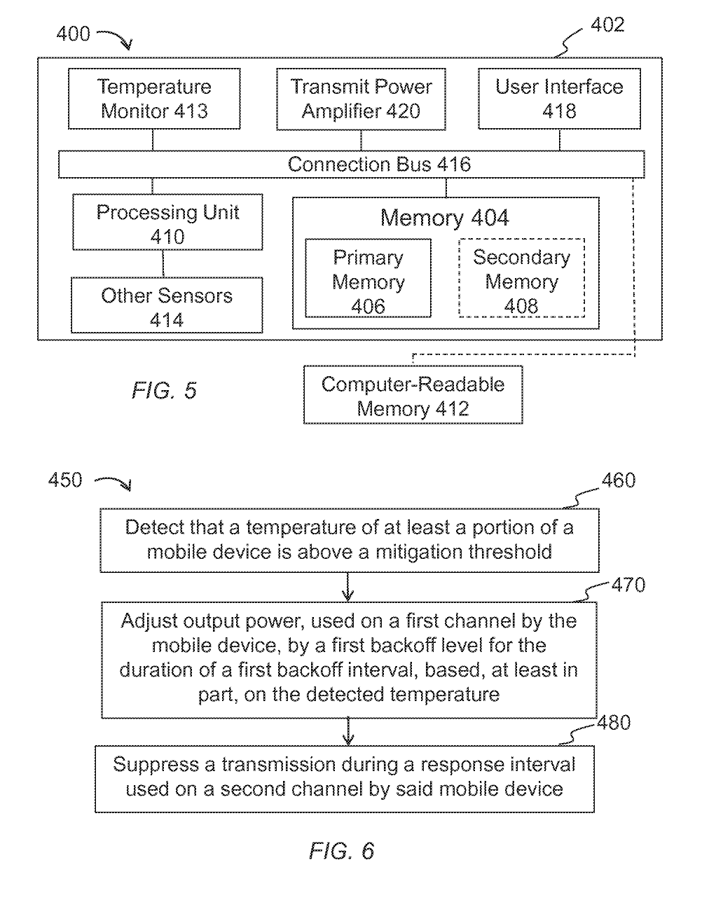

FIG. 6 is a flowchart (450) illustrating a process of temperature mitigation in a mobile device according to an implementation. Although the embodiment of FIG. 5 may be suitable for performing the method of FIG. 6, nothing prevents performing the method using alternative arrangements of structures and components. The method begins at block 460, which includes detecting a temperature of at least a portion of a mobile device is above a mitigation threshold. In block 460, an output signal of one or more temperature sensors may be used to detect a temperature. The method continues at block 470, which comprises adjusting output power, used on a first channel by the mobile device, by a first backoff level during a first backoff interval, based, at least in part, on the detected temperature. The method continues at 480, which includes suppressing a transmission during the response interval used on a second channel of the mobile device.

Methodologies described herein may be implemented by various means depending upon applications according to particular features or examples. For example, such methodologies may be implemented in hardware, firmware, software, discrete/fixed logic circuitry, any combination thereof, and so forth. In a hardware or logic circuitry implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices or units designed to perform the functions described herein, or combinations thereof, just to name a few examples.

For a firmware or software implementation, the methodologies may be implemented with modules (e.g., procedures, functions, etc.) having instructions that perform the functions described herein. Any machine-readable medium tangibly embodying instructions may be used in implementing the methodologies described herein. For example, software codes may be stored in a memory and executed by a processor. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored. In at least some implementations, one or more portions of the herein described storage media may store signals representative of data or information as expressed by a particular state of the storage media. For example, an electronic signal representative of data or information may be “stored” in a portion of the storage media (e.g., memory) by affecting or changing the state of such portions of the storage media to represent data or information as binary information (e.g., ones and zeros). As such, in a particular implementation, such a change of state of the portion of the storage media to store a signal representative of data or information constitutes a transformation of storage media to a different state or thing.

As was indicated, in one or more example implementations, the functions described may be implemented in hardware, software, firmware, discrete/fixed logic circuitry, some combination thereof, and so forth. If implemented in software, the functions may be stored on a physical computer-readable medium as one or more instructions or code. Computer-readable media include physical computer storage media. A storage medium may be any available physical medium that can be accessed by a computer. By way of example, and not limitation, such computer-readable media can comprise RAM, ROM, EEPROM, CD-ROM or other optical disc storage, magnetic disk storage or other magnetic storage devices, or any other medium that can be used to store desired program code in the form of instructions or data structures and that can be accessed by a computer or processor thereof. Disk and disc, as used herein, includes compact disc (CD), laser disc, optical disc, digital versatile disc (DVD), floppy disk and blue-ray disc where disks usually reproduce data magnetically, while discs reproduce data optically with lasers.

As discussed above, a mobile device may be capable of communicating with one or more other devices via wireless transmission or receipt of information over various communications networks using one or more wireless communication techniques. Here, for example, wireless communication techniques may be implemented using a wireless wide area network (WWAN), a wireless local area network (WLAN), a wireless personal area network (WPAN), or the like. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OF DMA) network, a Single-Carrier Frequency Division Multiple Access (SC-FDMA) network, a Long Term Evolution (LTE) network, a WiMAX (IEEE 802.16) network, and so on. A CDMA network may implement one or more radio access technologies (RATS) such as cdma2000, Wideband-CDMA (WCDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rdGeneration Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, or some other type of network, for example. The techniques may also be implemented in conjunction with any combination of WWAN, WLAN, or WPAN. Wireless communication networks may include so-called next generation technologies (e.g., “4G”), such as, for example, Long Term Evolution (LTE), Advanced LTE, WiMAX, Ultra Mobile Broadband (UMB), or the like.

In one particular implementation, a mobile device may, for example, be capable of communicating with one or more femtocells facilitating or supporting communications with the mobile device for the purpose of estimating its location, orientation, velocity, acceleration, or the like. As used herein, “femtocell” may refer to one or more smaller-size cellular base stations that may be enabled to connect to a service provider's network, for example, via broadband, such as, for example, a Digital Subscriber Line (DSL) or cable. Typically, although not necessarily, a femtocell may utilize or otherwise be compatible with various types of communication technology such as, for example, Universal Mobile Telecommunications System (UTMS), Long Term Evolution (LTE), Evolution-Data Optimized or Evolution-Data only (EV-DO), GSM, Worldwide Interoperability for Microwave Access (WiMAX), Code division multiple access (CDMA)-2000, or Time Division Synchronous Code Division Multiple Access (TD-SCDMA), to name just a few examples among many possible. In certain implementations, a femtocell may comprise integrated WiFi, for example. However, such details relating to femtocells are merely examples, and claimed subject matter is not so limited.

Also, computer-readable code or instructions may be transmitted via signals over physical transmission media from a transmitter to a receiver (e.g., via electrical digital signals). For example, software may be transmitted from a website, server, or other remote source using a coaxial cable, fiber optic cable, twisted pair, digital subscriber line (DSL), or physical components of wireless technologies such as infrared, radio, and microwave. Combinations of the above may also be included within the scope of physical transmission media. Such computer instructions or data may be transmitted in portions (e.g., first and second portions) at different times (e.g., at first and second times). Some portions of this Detailed Description are presented in terms of algorithms or symbolic representations of operations on binary digital signals stored within a memory of a specific apparatus or special purpose computing device or platform. In the context of this particular Specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and as used herein, may include a variety of meanings that also is expected to depend at least in part upon the context in which such terms are used. Typically, used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures or characteristics. However, it should be noted that this is merely an illustrative example and claimed subject matter is not limited to this example.

While certain example techniques have been described and shown herein using various methods or systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to particular examples disclosed, but that such claimed subject matter may also include all implementations falling within the scope of the appended claims, and equivalents thereof.

What is claimed is:

1. A method comprising:
detecting that a temperature of at least a portion of a mobile device is above a mitigation threshold;
adjusting transmit power, used on a first channel by said mobile device, by a first backoff amount during a first backoff interval, based, at least in part, on said detected temperature; and
suppressing a transmission during a response interval used on a second channel by said mobile device.

2. The method of claim 1, wherein said adjusting transmit power by said first backoff amount is performed during at least two backoff intervals of a first step timer period.

3. The method of claim 2, further comprising, in response to said first step timer period expiring:
determining whether said detected temperature of at least a portion of said mobile device remains above said mitigation threshold.

4. The method of claim 3, further comprising:
adjusting transmit power of said mobile device by a second backoff amount in response to said at least a portion of said mobile device remaining above said mitigation threshold.

5. The method of claim 4, wherein said second backoff amount is an integer multiple of said first backoff amount.

6. The method of claim 4, further comprising:
determining whether adjusting said transmit power by said second backoff amount results in a power level below a minimum transmit power level.

7. The method of claim 1, wherein said first backoff amount is based, at least in part, on entries from a lookup table.

8. The method of claim 1, wherein said first backoff amount is based, at least in part, on an output signal of a temperature-sensing control system.

9. An apparatus comprising:
means for detecting that a temperature of at least a portion of a mobile device is above a mitigation threshold;
means for adjusting transmit power used by said mobile device by a first backoff amount during a first backoff interval, and for suppressing transmissions during a response interval, based, at least in part, on said detected temperature.

10. The apparatus of claim 9, further comprising:
means for differentiating between a traffic channel and a control channel used by said mobile device;
means for adjusting transmit power used by said traffic channel of said mobile device by said first backoff amount; and
means for suppressing transmissions on said control channel used by said mobile device.

11. The apparatus of claim 10, wherein said means for adjusting transmit power used by said traffic channel comprises means for associating a measured temperature with a backoff amount.

12. The apparatus of claim of 10, wherein said means for suppressing transmissions on said control channel comprises means for associating a percentage of transmissions to be suppressed with a difference between a measured temperature and a temperature mitigation threshold.

13. The apparatus of claim 9, further comprising:
means for detecting that a second backoff amount does not reduce transmit power below a minimum transmit power level.

14. The apparatus of claim 1 further comprising:
means for adjusting transmit power of said mobile device by said second backoff amount in response to said detected temperature of said at least a portion of said mobile device remaining above said mitigation threshold.

15. An article comprising:
a non-transitory storage medium comprising machine-readable instructions stored thereon which are executable by a processor of a mobile device to:
detect that a temperature of at least a portion of said mobile device is above a mitigation threshold;
adjust transmit power of said mobile device by a first backoff amount during a first backoff interval based, at least in part, on said detected temperature; and
suppress a transmission during a response interval used on a second channel by said mobile device.

16. The article of claim 15, wherein said non-transitory storage medium further comprises machine-readable instructions stored thereon which are executable by said processor of said mobile device to:
indicate, by way of accessing a lookup table, said first backoff amount.

17. The article of claim 15, wherein said non-transitory storage medium further comprises machine-readable instructions stored thereon which are executable by said processor of said mobile device to:
indicate, by way of accessing a lookup table, a second backoff amount.

18. The article of claim 15, wherein said non-transitory storage medium further comprises machine-readable instructions stored thereon which are executable by said processor of said mobile device to:
adjust, by way of accessing a lookup table, a percentage of transmissions to be suppressed.

19. A mobile device comprising:
one or more temperature sensors: and
one or more processors to:
determine whether a signal from said one or more temperature sensors indicates that at least a portion of said mobile device has reached a temperature greater than a mitigation threshold;
adjust transmit power of said mobile device by a first backoff amount during a first backoff interval, based, at least in part, on an output signal of said one or more temperature sensors; and to
suppress a transmission during a response interval used on a second channel by said mobile device.

20. The mobile device of claim 19, wherein said one or more processors additionally adjusts transmit power of said mobile device by a second backoff amount in response to said at least a portion of said mobile device remaining above said mitigation threshold.

21. The mobile device of claim 19, wherein said one or more processors additionally adjusts transmit power of said mobile device by a second backoff amount in response to a first step timer expiring.

22. The mobile device of claim 19, wherein said one or more processors additionally determines whether adjusting said transmit power by a second backoff amount results in a power level below a minimum transmit power level.

23. The mobile device of claim 19, wherein said one or more processors additionally suppresses a higher percentage of transmissions during response intervals in response to an increase between a measured temperature and said mitigation threshold.
